(19) United States
(12) Patent Application Publication
(10) Pub. No.: US 2023/0325256 A1
(43) Pub. Date: Oct. 12, 2023

(54) DEEP NEURAL NETWORK MANAGEMENT OF OVERBOOKING IN A MULTI-TENANT COMPUTING ENVIRONMENT

(71) Applicant: International Business Machines Corporation, Armonk, NY (US)

(72) Inventors: Sheng Yan Sun, Beijing (CN); Meng Wan, Beijing (CN); Peng Hui Jiang, Beijing (CN); Hong Mei Zhang, Beijing (CN)

(21) Appl. No.: 17/656,081

(22) Filed: Mar. 23, 2022

(51) Int. Cl. G06N 3/10; G06N 5/00; G06F 9/50; G06F 9/455; G06N 3/08

(52) U.S. Cl. CPC G06F 9/5077; G06F 9/45558; G06N 3/088; G06N 3/10; G06N 5/003; G06F 2009/4557

(57) ABSTRACT

A processor receives an optimization target for a first cluster in a distributed computing environment. A processor trains a neural network based on the optimization target. A processor generates a decision tree based on the neural network. A processor selects a workload executing in the first cluster of the distributed computing environment. A processor identifies a second cluster to relocate the workload. A processor determines a current optimization of the distributed computing environment based on the workload being retained in the first cluster. A processor determines a migration optimization of the distributed computing environment based on the workload being migrated to the second cluster. A processor, in response to the migration optimization improving the current optimization of the distributed computing environment, migrates the workload to the second cluster.

### BACKGROUND OF THE INVENTION

The present invention relates generally to the field of cloud computing, and more particularly to managing overbooking with a deep neural network.

With the fast development in cloud technology, more and more services have been migrated to cloud platforms. Services hosted on cloud platforms can benefit from the relative cheaper but higher performance system resources of cloud capacity. For example, the more system resources a database service takes from the cloud platform, the more expenses the tenant utilizing the database. The concept of “tenant” is not limited to the users of a cluster in the cloud platform. It can include a set of workloads composed of computing, network, storage and other resources. In a multi-tenant cluster, different tenants need to be isolated within a cluster (which may be multiple clusters in the future) to avoid attacks by malicious tenants on other tenants to the greatest extent, and to ensure fair distribution of shared cluster resources among tenants.

Additionally, cloud platforms try to avoid high vacancy rate in clusters and attempt to utilize of the most of the resources deployed in each cluster. However, there will be a certain amount of overbooking, or over allocation of tenants to a cluster. It is quite often that only a percentage of tenants are using a resource or service in the cloud platform at a given time. However, it is inevitable that tenants exceed this typical usage and requires to the tenant’s workloads to be moved, or expelled, from the cluster.

### SUMMARY

Embodiments of the present invention provide a method, system, and program product to manage overbooking in a distributed computing environment is provided. A processor receives an optimization target for a first cluster in a distributed computing environment. A processor trains a neural network based on the optimization target. A processor generates a decision tree based on the neural network. A processor selects a workload executing in the first cluster of the distributed computing environment. A processor identifies a second cluster to relocate the workload. A processor determines a current optimization of the distributed computing environment based on the workload being retained in the first cluster. A processor determines a migration optimization of the distributed computing environment based on the workload being migrated to the second cluster. A processor, in response to the migration optimization improving the current optimization of the distributed computing environment, migrates the workload to the second cluster.

### BRIEF DESCRIPTION OF THE SEVERAL VIEWS OF THE DRAWINGS

FIG. 1 depicts a cloud computing environment according to an embodiment of the present invention.

FIG. 2 depicts abstraction model layers according to an embodiment of the present invention.

FIG. 3 illustrates a computing environment for managing workloads in a cloud computing environment.

FIG. 4 illustrates operational processes of optimizing workloads in a cluster within a computing cloud environment.

FIG. 5 depicts a block diagram of components of the computing device executing a workload optimizer, in accordance with an exemplary embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

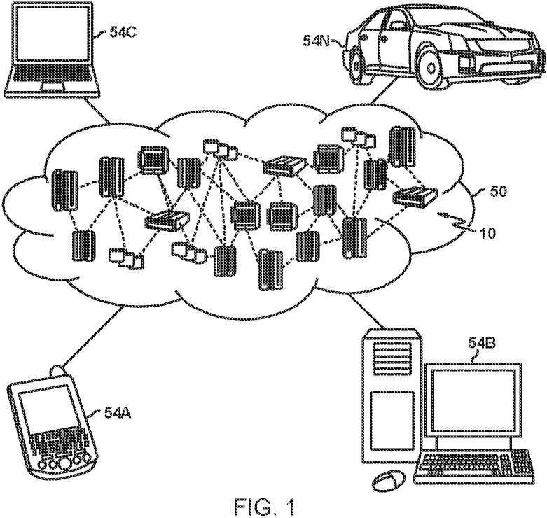

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

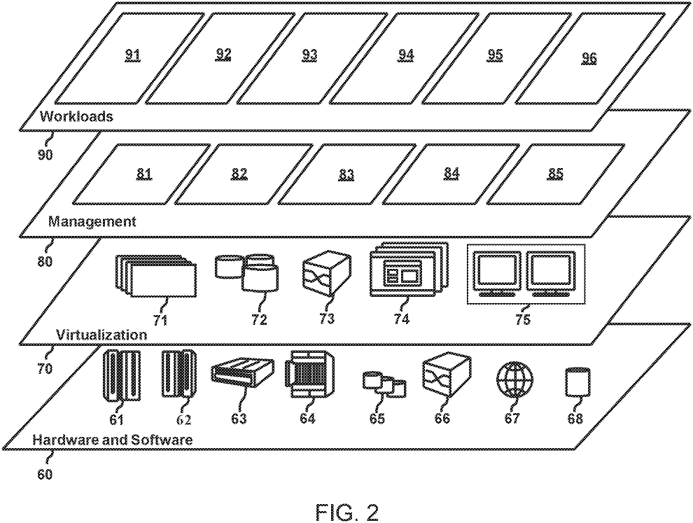

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Metering and Pricing 81 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 82 provides access to the cloud computing environment for consumers and system administrators. Service level management 83 provides cloud computing resource allocation and management such that required service levels are met. Service Level Agreement (SLA) planning and fulfillment 84 provide pre-arrangement for, and procurement of, cloud computing resources for which a future requirement is anticipated in accordance with an SLA. Resource provisioning 85 provides dynamic procurement of computing resources and other resources that are utilized to perform tasks within the cloud computing environment.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and microservices 96.

The present invention will now be described in detail with reference to the Figures. FIG. 1 is a functional block diagram illustrating workload management environment, generally designated 100, in accordance with one embodiment of the present invention. Workload management environment 100 includes tenant(s) 110a-n, Cluster A 120, workload(s) 125a-n, Cluster B 130, workloads 135-a-n and workload optimizer 140.

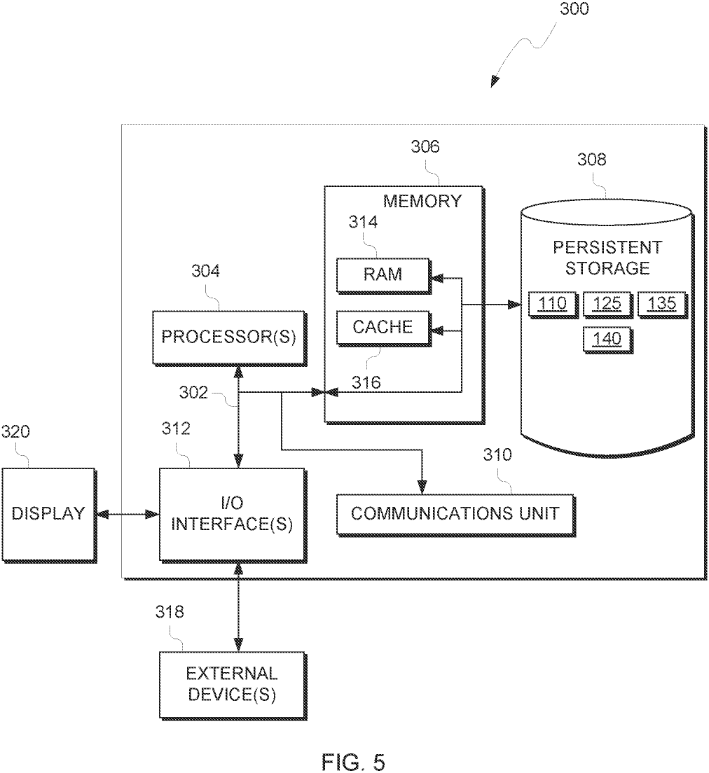

In various embodiments of the present invention, tenant(s) 110a-n, Cluster A 120, Cluster B 130, and workload optimizer 140 are each a computing device that can be a standalone device, a server, a laptop computer, a tablet computer, a netbook computer, a personal computer (PC), or a desktop computer. In another embodiment, tenant(s) 110a-n, Cluster A 120, Cluster B 130, and workload optimizer 140 represents a computing system utilizing clustered computers and components to act as a single pool of seamless resources. In general, tenant(s) 110a-n, Cluster A 120, Cluster B 130, and workload optimizer 140 can be any computing device or a combination of devices with access to workloads 125a-n and workloads 135 a-n. Tenant(s) 110a-n, Cluster A 120, Cluster B 130, and workload optimizer 140 may each include internal and external hardware components, as depicted and described in further detail with respect to FIG. 5.

In this exemplary embodiment, workload optimizer 140 is part of management layer 80 of cloud computing environment 50. However, in other embodiments, workload optimizer 140 may be stored externally and accessed through a communication network. The network can be, for example, a local area network (LAN), a wide area network (WAN) such as the Internet, or a combination of the two, and may include wired, wireless, fiber optic or any other connection known in the art. In general, the network can be any combination of connections and protocols that will support communications between Tenant(s) 110a-n, Cluster A 120, Cluster B 130, and workload optimizer 140, in accordance with a desired embodiment of the present invention.

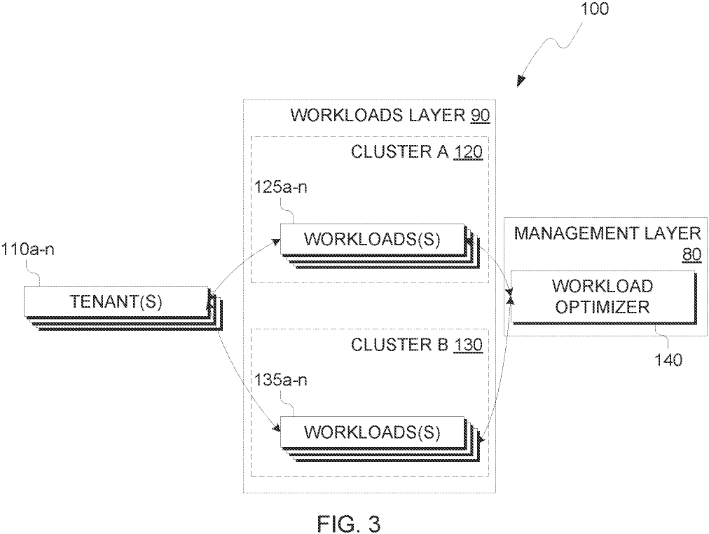

In various embodiments, workloads layer 90 of cloud computing environment 50 is partitioned into more than one cluster. Clusters are a group of two or more computers, or nodes, that run in parallel to achieve a common goal. This allows workloads consisting of a high number of individual, parallelizable tasks to be distributed among the nodes in the cluster. As a result, these tasks can leverage the combined memory and processing power of each computer or device in the cluster to increase overall performance. FIG. 3 depicts two clusters, Cluster A 120 and Cluster B 130 to simplify the discussion of the invention. However, one of ordinary skill in the art will appreciate that cloud computing environment 50 may provide and manage workloads across more than two clusters.

In various embodiments, both Cluster A 120 and Cluster B 130 have currently executing workloads 125a-n and 135a-n, respectively. A tenant, of tenants 110a-n, requests for a workload to be executed within cloud computing environment 50. Management layer 80 determines where to instantiate the workload based on current usage metrics for each cluster. Once a workload is executing in the cloud computing environment 50, workload optimizer 140 monitors each cluster in workloads layer 90. As discussed herein, workload optimizer 140 builds a deep neural network (DNN) model for various types of optimization targets, which is trained on workload balances that maximize the various types of optimization targets. Example optimization targets includes, but are not limited to, processor utilization, memory utilization, Input/Output (I/O) utilization, and storage utilization.

In some embodiments, the DNN model comprises an autoencoder. Autoencoders are composed of multiple layers, with one or more input layers that contain exactly as much information as the output layer. Autoencoders take one situation or desired output as input into the model. The neural network then learns how to map the desired input to the output lay of the DNN. The reason that the input layer and output layer has the exact same number of units is that an autoencoder aims to replicate the input data. It outputs a copy of the data after analyzing it and reconstructing it in an unsupervised fashion. The data that moves through an autoencoder isn’t just mapped straight from input to output, meaning that the network doesn’t just copy the input data. There are three components to an autoencoder: an input layer that compresses the data, a hidden layer that has fewer connections than the input and output layer, and an output layer that includes values for a desired result or previous outcome. When data is fed into an autoencoder, it is encoded and then compressed down to a smaller size. The network is then trained on the encoded/compressed data and outputs a recreation of that data.

In various embodiments, workload optimizer 140 generates the DNN model based on current workload profile data of executing workloads 125a-n and 135a-n. Feeding into the input layer of the autoencoder DNN, workload optimizer 140 selects currently executing or historic workload data regarding usage patterns of the current or historic workloads in a first cluster, such as Cluster A 120. For example, workload data may include, but is not limited to, CPU usage, memory allocated, and other resource usage metrics. Workload optimizer 140 then maps previous or current workloads executing in another cluster, such as Cluster B 130. to the output layer of the autoencoder DNN. Previous workload migrations include workloads that were moved to another cluster in addition to the workload profile data of the workloads when migrated. Then workload optimizer 140 trains the hidden layer by matching the input and output layers, within a certain degree of confidence or error. Once a hidden layer mapping is trained, workload optimizer 140 can deploy the autoencoder DNN to determine optimal workload migrations between clusters. By doing so, workload optimizer 140 can predict which, if any, workload migrations between clusters will optimize workloads between clusters in cloud computing environment 50.

In various embodiments, the DNN model is trained using production data from previous operations and workloads executed in a cluster. Workload optimizer 140 utilizes the DNN model to compare similar cluster and other deployments to model the affects workloads have on the provisioning of a cluster. In some embodiments, various DNN model are maintained for various scenarios of customer requirements via application or microservice level, capture and identify business requirement parameters. For example, each application, microservice or workload includes requirements for typical usage indicating the amount of utilization for the following: CPU/processor, Memory, DBD Pool, Package Storage, Log Dataset IO, Dynamic Cache, and Virtual Storage.

In various embodiments, Workload optimizer 140 identifies cloud computing system resource parameters and builds a decision tree for consolidating different grouping tenant together. Workload optimizer 140 identifies an optimization to model for a cluster such as, but not limited to, processor utilization, memory utilization, Input/Output (I/O) utilization, and storage utilization. For each workload in a cluster, workload optimizer 140 evaluates the decision tree for other clusters in cloud computing environment 50. For example, workload optimizer 140 evaluates migrating each workload of workloads 125a-n for migration to cluster B 130.

In various embodiments, workload optimizer 140 constructs the decision trees for each cluster based on the current workload profile of current and historic workloads for the cluster, or type of cluster. Workload optimizer 140 extracts workload profile from a current or previous batch or workloads in the cluster (e.g., workload 125a-n). Then workload optimizer 140 selects the attribute value to be optimized (e.g. CPU or memory utilization). In some scenarios, each workload of a given tenant is grouped as a partition. In various embodiments, workload optimizer 140 compares each workload to other clusters, calculating the how the workload affects other clusters if migrated. The decision tree is updated with each optimal migration to minimize the loss function in order to combat overfitting.

In various embodiments, once the decision tree has bee updated for each candidate workload to be evaluated for migration, workload optimizer 140 determines the loss or change in utilization for the current cluster. In turn, workload optimizer 140 evaluates the decision tree for the other cluster until the lost utilization is minimized across clusters. In various embodiments, workload optimizer 140 bundles workloads for migration from one cluster to another based on the optimization determined by the autoencoder DNN model and current workload profile data for each cluster.

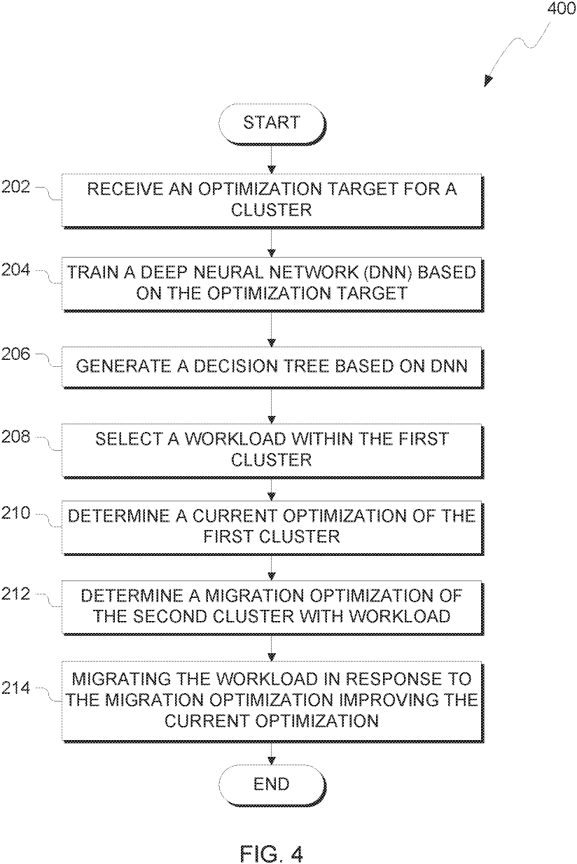

FIG. 4 illustrates operational processes, generally designated 400, of optimizing workloads in a cluster within computing cloud environment 50. In process 202, workload optimizer 140 receives an optimization target for a cluster. Clusters within computing cloud environment 50 may need optimization for various resource types. Migration can affect each optimization differently. As such, workload optimizer 140 includes various trained Deep Neural Network (DNN) models for each optimization target. Example optimizations include, but are not limited to, processor utilization, memory utilization, Input/Output (I/O) utilization, and storage utilization.

In process 204, workload optimizer 140 trains the DNN models for the selected optimization targets. For example, for a CPU optimization target, workload optimizer 140 monitors workloads 125a-n or 135a-n to train the DNN models. In process 206, workload optimizer 140 generates a decision tree based on the selected DNN. The decision tree is generated for each evaluation based on learned migration patterns derived from the DNN model, as well as the current workload parameters of the cluster.

In process 208, workload optimizer 140 selects candidate workloads for migration to another cluster within cloud computing environment 50. For each workload, workload optimizer 140 determine the current optimization of the cluster where the candidate workload resides. Based on the received target optimization, workload optimizer 140 determine the current optimization of the target feature (e.g., CPU utilization or I/O utilization). In process 212, workload optimizer 140 determines the migration optimization for the workload. The migration optimization indicates the changes in utilization if the workload was migrated to the other cluster. Workload optimizer 140 repeats processes 210 and 212 as workloads are simulated for migrating across each cluster. In process 214, once the migration optimization exceeds the current optimization of the cluster, then workload optimizer 140 migrates the workloads that increase the current optimization of the clusters.

FIG. 5 depicts a block diagram, 300, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Tenant(s) 110a-n, workloads 125a-n and 135 a-n, and workload optimizer 140 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of cloud computing environment 50. In these examples, communications unit 310 includes one or more network interface cards. Communications unit 310 may provide communications through the use of either or both physical and wireless communications links. Tenant(s) 110a-n, workloads 125a-n and 135 a-n, and workload optimizer 140 may be downloaded to persistent storage 308 through communications unit 310.

I/O interface(s) 312 allows for input and output of data with other devices that may be connected to computing device 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., Tenant(s) 110an, workloads 125a-n and 135 a-n, and workload optimizer 140, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
receiving, by one or more processors, an optimization target for a first cluster in a distributed computing environment;
training, by the one or more processors, a neural network based on the optimization target;
generating, by the one or more processors, a decision tree based on the neural network;
selecting, by the one or more processors, a workload executing in the first cluster of the distributed computing environment;
identifying, by the one or more processors, a second cluster to relocate the workload;
determining, by the one or more processors, a current optimization of the distributed computing environment based on the workload being retained in the first cluster;
determining, by the one or more processors, a migration optimization of the distributed computing environment based on the workload being migrated to the second cluster; and
in response to the migration optimization improving the current optimization of the distributed computing environment, migrating, by the one or more processers, the workload to the second cluster.

2. The method of claim 1, wherein the optimization target is selected from one of the following: processor utilization, memory utilization, Input/Output (I/O) utilization, and storage utilization.

3. The method of claim 1, wherein the neural network comprises an autoencoder neural network.

4. The method of claim 3, wherein an input layer of the autoencoder neural network includes data from workload profiles executing in the first cluster and the output layer of the autoencoder neural network includes data from workload profiles executing in the second cluster.

5. The method of claim 4, wherein a hidden layer of the autoencoder neural network predicts optimization of workload when migrated from the first cluster to the second cluster.

6. The method of claim 5, wherein the hidden layer includes one or more features corresponding to the received optimization target.

7. The method of claim 1, wherein the decision tree is generated based on one or more workload profiles for the first cluster and the second cluster.

8. A computer program product comprising:
one or more computer-readable storage media and program instructions stored on the one or more computer-readable storage media, the program instructions comprising:
program instructions to receive an optimization target for a first cluster in a distributed computing environment;
program instructions to train a neural network based on the optimization target;
program instructions to generate a decision tree based on the neural network;
program instructions to select a workload executing in the first cluster of the distributed computing environment;
program instructions to identify a second cluster to relocate the workload;
program instructions to determine a current optimization of the distributed computing environment based on the workload being retained in the first cluster;
program instructions to determine a migration optimization of the distributed computing environment based on the workload being migrated to the second cluster; and
program instructions, in response to the migration optimization improving the current optimization of the distributed computing environment, to migrate the workload to the second cluster.

9. The computer program product of claim 8, wherein the optimization target is selected from one of the following: processor utilization, memory utilization, Input/Output (I/O) utilization, and storage utilization.

10. The computer program product of claim 8, wherein the neural network comprises an autoencoder neural network.

11. The computer program product of claim 10, wherein an input layer of the autoencoder neural network includes data from workload profiles executing in the first cluster and the output layer of the autoencoder neural network includes data from workload profiles executing in the second cluster.

12. The computer program product of claim 11, wherein a hidden layer of the autoencoder neural network predicts optimization of workload when migrated from the first cluster to the second cluster.

13. The computer program product of claim 12, wherein the hidden layer includes one or more features corresponding to the received optimization target.

14. The computer program product of claim 8, wherein the decision tree is generated based on one or more workload profiles for the first cluster and the second cluster.

15. A computer system comprising:
one or more computer processors;
one or more computer readable storage media; and
program instructions stored on the computer readable storage media for execution by at least one of the one or more processors, the program instructions comprising:
program instructions to receive an optimization target for a first cluster in a distributed computing environment;
program instructions to train a neural network based on the optimization target;
program instructions to generate a decision tree based on the neural network;
program instructions to select a workload executing in the first cluster of the distributed computing environment;
program instructions to identify a second cluster to relocate the workload;
program instructions to determine a current optimization of the distributed computing environment based on the workload being retained in the first cluster;
program instructions to determine a migration optimization of the distributed computing environment based on the workload being migrated to the second cluster; and
program instructions, in response to the migration optimization improving the current optimization of the distributed computing environment, to migrate the workload to the second cluster.

16. The computer system of claim 15, wherein the optimization target is selected from one of the following: processor utilization, memory utilization, Input/Output (I/O) utilization, and storage utilization.

17. The computer system of claim 15, wherein the neural network comprises an autoencoder neural network.

18. The computer system of claim 17, wherein an input layer of the autoencoder neural network includes data from workload profiles executing in the first cluster and the output layer of the autoencoder neural network includes data from workload profiles executing in the second cluster.

19. The computer system of claim 18, wherein a hidden layer of the autoencoder neural network predicts optimization of workload when migrated from the first cluster to the second cluster.

20. The computer system of claim 19, wherein the hidden layer includes one or more features corresponding to the received optimization target.
